(19) United States
(12) Patent Application Publication
(10) Pub. No.: US 2010/0037003 A1
(43) Pub. Date: Feb. 11, 2010

(54) FLASH MEMORY CONTROL APPARATUS HAVING SIGNAL-CONVERTING MODULE

(75) Inventors: Ju-peng Chen, Taipei City (TW); Yu-jen Hsu, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/327,065

(22) Filed: Dec. 3, 2008

(30) Foreign Application Priority Data
Aug. 6, 2008 (TW) 097129871

(51) Int. Cl. G06F 12/00

(52) U.S. Cl. 711/103

(57) ABSTRACT

A flash memory control apparatus having a signal-converting module is described. The signal-converting module includes a primary controller, a signal-converting module, a data buffer, and a secondary controller. The primary controller generates a plurality of control signals based on a first control interface. The signal-converting module receiving a reading enable signal and a writing enable signal of the control signals and converts the reading enable signal and the writing enable signal into a writing/reading signal based on a second control interface. The data buffer stores the data from the primary controller according to the first control interface and stores the data from the flash memory according to the second control interface. The secondary controller transmits the writing/reading signal, a clock signal and a data strobe signal to the flash memory based on the second control interface.

### FIELD OF THE INVENTION

The present invention relates to a memory apparatus, and more particularly relates to a flash memory control apparatus having a signal-converting module which is applicable to NAND (Not AND) flash memory.

### BACKGROUND OF THE INVENTION

With the rapid development of flash memory, a variety of flash memory interface specifications, such as NAND (Not AND) flash, are widely utilized. For performance improvement of the NAND flash memory, one kind of flash interface, e.g. open NAND flash interface (ONFI) standard protocol, is thus established. However, the interface specification of the conventional NAND flash memory cannot be compatible to the interface of the ONFI flash memory. Particularly, the pin assignments of the conventional NAND flash memory are different from these of the ONFI flash memory. Generally speaking, the ONFI flash memory only supports the type of on-die controller. Therefore, these products adopting the old NAND flash memory need to be re-designed so as to meet the standard protocol of the interface of ONFI flash memory, thereby resulting in no cost-effectiveness. Consequentially, there is a need to develop a novel flash memory to solve the aforementioned problem.

### SUMMARY OF THE INVENTION

The objective of the present invention is to provide a flash memory control apparatus having a signal-converting module based on one flash memory interface to be compatible to another flash memory interface, such as ONFI flash memory.

According to the above objective, the present invention sets forth a flash memory control apparatus having a signal-converting module. The flash memory control apparatus includes a primary controller, a signal-converting module, a data buffer, and a secondary controller. The flash memory control apparatus is used to control a flash memory. The signal-converting module is coupling the primary controller to the secondary controller therebetween. The data buffer is coupling the primary controller to the secondary controller therebetween. The secondary controller is coupled to the flash memory.

The primary controller generates a first set of control signals based on a first control interface. The first set of control signals further includes a reading enable signal and a writing enable signal. The signal-converting module receives the reading enable signal and the writing enable signal from the primary controller. The signal-converting module further converts both the reading enable signal and the writing enable signal into a writing/reading signal based on a second control interface. For example, while the writing/reading signal is high level, the data are sent to the flash memory. Conversely, while the writing/reading signal is high level, the data are outputted from the flash memory.

The first set of control signals based on the first control interface includes a command latch enable signal (SCLE), a chip enable signal (/SCE), a write enable signal (/SWE), an address latch enable signal (SALE), a read enable signal (/SRE), an input/output (I/Ox) signal, a write protecting signal (/WP), and a ready/busy (R/B) status signal. The second set of control signals based on the second control interface includes a command latch enable signal (SCLE), a chip enable signal (/SCE), a writing/reading signal /(W/R), an address latch enable signal (SALE), a data strobe signal (DQS), a DQx signal, a clock signal (CLK), a write protecting signal (IWP), and a ready/busy (R/B) status signal. In the present invention, “asynchronous” indicates that the data are latched with /SWE signal during the writing procedure and the data are latched with /SRE signal during the reading procedure. “Synchronous represents when the strobe signal (DQS) is forwarded the data to indicate when the data should be latched.

The command latch enable signal (SCLE) is one of the signals used by the host to indicate the type of bus cycle including command, address, and data. The chip enable signal (/SCE) is used to select the flash memory. When the chip enable signal (/SCE) is high and the flash memory is in the ready state, the flash memory goes into a low-power standby state. When chip enable signal (/SCE) is low, the flash memory is selected. The address latch enable signal (SALE) is used by the flash memory control apparatus to indicate the type of bus cycle including command, address, and data.

The writing/reading signal /(W/R) indicates the owner of the DQx bus and data strobe signal (DQS) in the source synchronous data interface. The writing/reading signal /(W/R) shares the same pin as the read enable signal (/SRE) in the asynchronous data interface. The data strobe signal (DQS) that indicates the data valid window for the source synchronous data interface. The strobe signal, DQS, can be regarded as an additional control bit of data bus. The I/O port for the DQx signal is a bidirectional port for transferring address, command, and data to and from the flash memory.

The clock signal (CLK) is used as the clock in the source synchronous data interface. In one embodiment, the clock signal (CLK) shares the same pin as write enable signal (/SWE) in the source asynchronous data interface based on the first control interface. The write protecting signal (/WP) enables/disables the flash array program and erase operations. The ready/busy (R/B) signal indicates the status of the flash memory.

According to the above-mentioned descriptions, the present invention provides a flash memory control apparatus based on one flash memory interface to be compatible to another flash memory interface, such as ONFI flash memory.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a flash memory control apparatus having a signal-converting module according to one embodiment of the present invention;

FIG. 2 is a schematic timing diagram of an asynchronous reading procedure of the flash memory control apparatus based on a first control interface according to one embodiment of the present invention; and

FIG. 3 is a schematic timing diagram of a synchronous reading procedure of the flash memory control apparatus based on a second control interface according to one embodiment of the present invention.

### DETAILED DESCRIPTION OF THE PREFERRED EMBODIMENTS

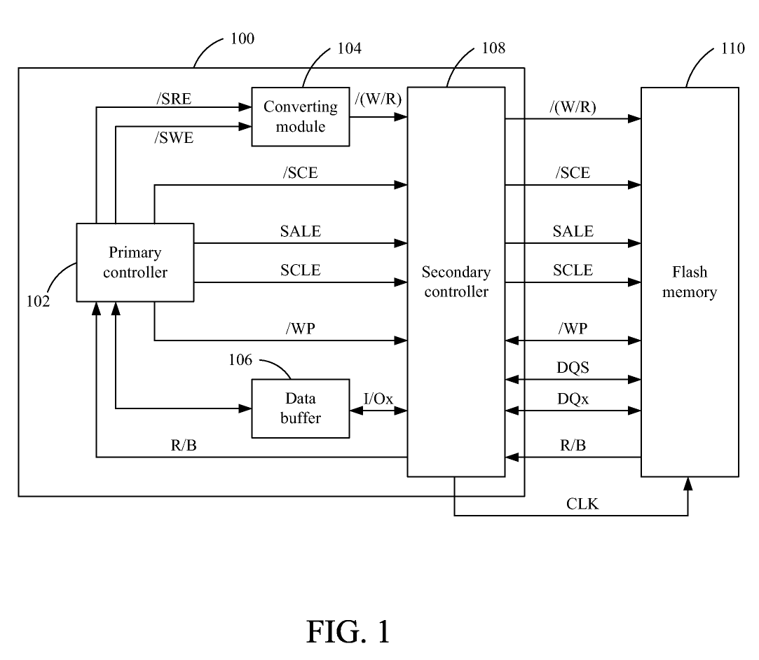

FIG. 1 is a schematic block diagram of a flash memory control apparatus 100 having a signal-converting module 104 according to one embodiment of the present invention. The flash memory control apparatus 100 includes a primary controller 102, a signal-converting module 104, a data buffer 106, and a secondary controller 108. The flash memory control apparatus 100 is used to control a flash memory 110. The signal-converting module 104 is coupling the primary controller 102 to the secondary controller 108 therebetween. The data buffer 106 is coupling the primary controller 102 to the secondary controller 108 therebetween. The secondary controller 108 is coupled to the flash memory 110.

The primary controller 102 generates a first set of control signals based on a first control interface. The first set of control signals further includes a reading enable signal and a writing enable signal. The signal-converting module 104 receives the reading enable signal and the writing enable signal from the primary controller 102. The signal-converting module 104 further converts both the reading enable signal and the writing enable signal into a writing/reading signal based on a second control interface. For example, while the writing/reading signal is high level, the data are sent to the flash memory 110. Conversely, while the writing/reading signal is high level, the data are outputted from the flash memory 110.

The data buffer 106 stores the data from the primary controller 102 according to the first control interface and stores the data from the flash memory 110 according to the second control interface. The secondary controller 108 generates a second set of control signals based on the second control interface. The second set of control signals further includes a clock signal and a strobe signal. The secondary controller 108 further transmits the writing/reading signal, the clock signal and the data strobe signal to the flash memory 110 based on the second control interface for reading the data from the flash memory 110 or writing the data to the flash memory 110. In one embodiment, the clock signal is used to latch command and address. During the data phase of reading or writing the data, the rising and falling edge of the data strobe signal corresponds to a data byte. For example, during the center-aligned duration of the strobe signal, the data are sent to the flash memory 110. During edge-aligned duration of the strobe signal, the data are written to the flash memory 110.

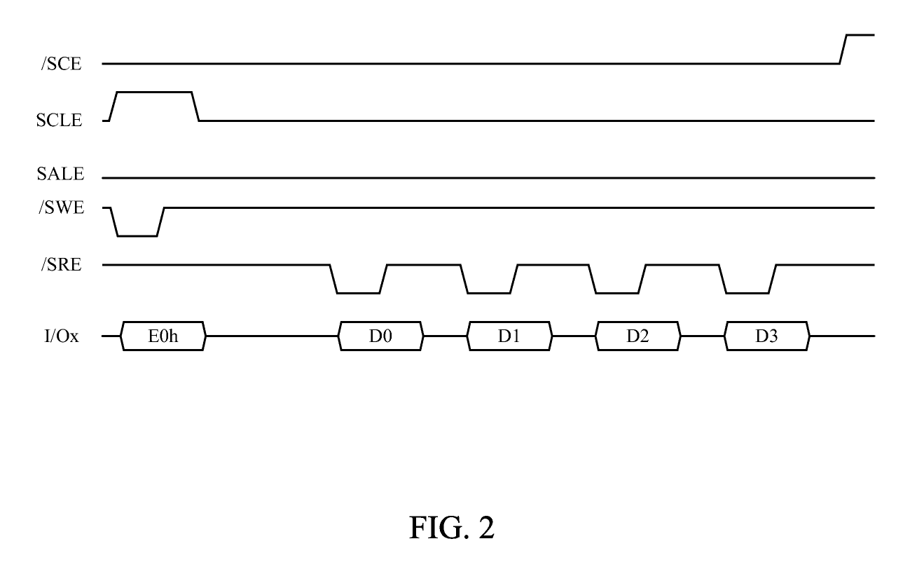

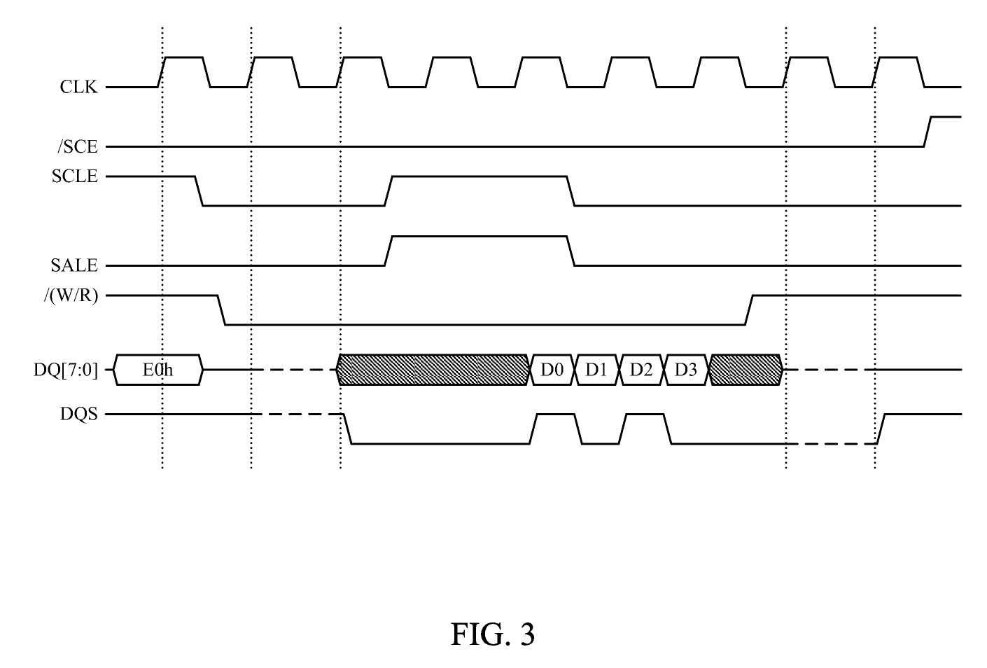

The first set of control signals further includes a command latch enable signal (SCLE), a chip enable signal (/SCE), an address latch enable signal (SALE), and a write protecting signal (IWP) based on the first control interface. The first set of control signals based on the first control interface will be described in FIG. 2. The second set of control signals further includes a command latch enable signal (SCLE), a chip enable signal (/SCE), an address latch enable signal (SALE), and a write protecting signal (/WP) based on the second control interface. The second set of control signals based on the second control interface will be described in FIG. 3. The secondary controller 108 further receives a ready/busy (R/B) status signal from the flash memory 110 based on the second control interface. The primary controller 102 further receives the ready/busy (R/B) status signal from the secondary controller 108 based on the first control interface. In one embodiment, the first control interface is compatible to the NAND flash standard protocol. The second control interface is compatible to the open NAND flash interface (ONFI) standard protocol.

Please refer to FIG. 1 and FIG. 2. FIG. 2 is a schematic timing diagram of an asynchronous reading procedure of the flash memory control apparatus based on a first control interface according to one embodiment of the present invention. The first set of control signals based on the first control interface includes a command latch enable signal (SCLE), a chip enable signal (/SCE), a write enable signal (/SWE), an address latch enable signal (SALE), a read enable signal (/SRE), an input/output (I/Ox) signal, a write protecting signal (IWP), and a ready/busy (R/B) status signal. In the present invention, “asynchronous” indicates that the data are latched with /SWE signal during the writing procedure and the data are latched with /SRE signal during the reading procedure.

The chip enable signal (/SCE) is used to actuate the flash memory 110 while the flash memory 110 is enabled by the secondary controller 108 of the flash memory control apparatus 100. For example, the flash memory 110 is active while the chip enable signal (/SCE) is at low level. The write enable signal (/SWE) represents that the flash memory 110 can be written by the secondary controller 108 of the flash memory control apparatus 100 while the write enable signal (/SWE) is active, e.g. at a low level.

The read enable signal (/SRE) represents that the flash memory 110 can be read by the secondary controller 108 of the flash memory control apparatus 100 while the read enable signal (/SRE) is active, e.g. at a low level. While the command latch enable signal (SCLE) is active, the command is latched at the rising edge of the write enable signal (/SWE). While the address latch enable signal (SALE) is active, the address is latched at the rising edge of the write enable signal (/SWE). The input/output (I/Ox) signal represents the data signal transferred between the flash memory 110 and the data buffer 108 of the flash memory control apparatus 100. The ready/busy (R/B) status signal represents the status of the flash memory 110 to be reported to the flash memory control apparatus 100.

FIG. 3 is a schematic timing diagram of a synchronous reading procedure of the flash memory control apparatus based on a second control interface according to one embodiment of the present invention. The second set of control signals based on the second control interface includes a command latch enable signal (SCLE), a chip enable signal (/SCE), a writing/reading signal /(W/R), an address latch enable signal (SALE), a data strobe signal (DQS), a DQx signal, a clock signal (CLK), a write protecting signal (/WP), and a ready/busy (R/B) status signal. “synchronous represents when the strobe signal (DQS) is forwarded the data to indicate when the data should be latched.

The command latch enable signal (SCLE) is one of the signals used by the host to indicate the type of bus cycle including command, address, and data. The chip enable signal (/SCE) (e.g. active low) is used to select the flash memory 110. When the chip enable signal (/SCE) is high and the flash memory 110 is in the ready state, the flash memory 110 goes into a low-power standby state. When chip enable signal (/SCE) is low, the flash memory 110 is selected. The address latch enable signal (SALE) is used by the flash memory control apparatus 100 to indicate the type of bus cycle including command, address, and data.

The writing/reading signal /(W/R) indicates the owner of the DQx bus and data strobe signal (DQS) in the source synchronous data interface. The writing/reading signal /(W/R) shares the same pin as the read enable signal (/SRE) in the asynchronous data interface. The data strobe signal (DQS) that indicates the data valid window for the source synchronous data interface. The strobe signal, DQS, can be regarded as an additional control bit of data bus. The I/O port for the DQx signal is a bidirectional port, such as 8-bit wide, for transferring address, command, and data to and from the flash memory 110. For example, DQ0˜DQ7 (DQ[7:0]) of the DQx signal are for the source synchronous data interface.

The clock signal (CLK) is used as the clock in the source synchronous data interface. In one embodiment, the clock signal (CLK) shares the same pin as write enable signal (/SWE) in the source asynchronous data interface based on the first control interface. The write protecting signal (IWP) enables/disables the flash array program and erase operations. The ready/busy (R/B) signal indicates the status of the flash memory.

According to the above-mentioned descriptions, the present invention provides a flash memory control apparatus having a signal-converting module based on one flash memory interface to be compatible to another flash memory interface, such as ONFI flash memory.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A flash memory control apparatus for controlling a flash memory, the flash memory control apparatus comprising:
a primary controller, generating a first set of control signals based on a first control interface, wherein the first set of control signals further comprises a reading enable signal and a writing enable signal;
a signal-converting module coupled to the primary controller, receiving the reading enable signal and the writing enable signal and converting the reading enable signal and the writing enable signal into a writing/reading signal based on a second control interface;
a data buffer coupled to the primary controller, storing the data from the primary controller according to the first control interface and storing the data from the flash memory according to the second control interface; and
a secondary controller coupled to the primary controller, the signal-converting module and the data buffer, respectively, generating a second set of control signals based on the second control interface wherein the second set of control signals further comprises a clock signal and a strobe signal, and transmitting the writing/reading signal, the clock signal and the data strobe signal to the flash memory based on the second control interface for reading the data from the flash memory or writing the data to the flash memory.

2. The flash memory control apparatus of claim 1, wherein the first set of control signals further comprises a command latch enable signal (SCLE), a chip enable signal (/SCE), an address latch enable signal (SALE), and a write protecting signal (IWP) based on the first control interface.

3. The flash memory control apparatus of claim 1, wherein the second set of control signals further comprises a command latch enable signal (SCLE), a chip enable signal (/SCE), an address latch enable signal (SALE), and a write protecting signal (/WP) based on the second control interface.

4. The flash memory control apparatus of claim 1, wherein the secondary controller further receives a ready/busy (R/B) status signal from the flash memory based on the second control interface.

5. The flash memory control apparatus of claim 4, wherein the primary controller further receives the ready/busy (R/B) status signal from the secondary controller further based on the first control interface.

6. The flash memory control apparatus of claim 1, wherein the first control interface is compatible to NAND flash standard protocol.

7. The flash memory control apparatus of claim 1, wherein the second control interface is compatible to an open NAND flash interface standard protocol.

8. A flash memory control apparatus for controlling a flash memory, the flash memory control apparatus comprising:
a primary controller, generating a first set of control signals based on a first control interface, wherein the first set of control signals further comprises a reading enable signal and a writing enable signal;
a signal-converting module coupled to the primary controller, receiving the reading enable signal and the writing enable signal and converting the reading enable signal and the writing enable signal into a writing/reading signal based on a second control interface; and
a secondary controller coupled to the primary controller and the signal-converting module, respectively, generating a second set of control signals based on the second control interface wherein the second set of control signals further comprises a clock signal and a strobe signal, and the secondary controller transmitting the writing/reading signal, the clock signal and the data strobe signal to the flash memory based on the second control interface for reading the data from the flash memory or writing the data to the flash memory.

9. The flash memory control apparatus of claim 8, wherein the first set of control signals further comprise a command latch enable signal (SCLE), a chip enable signal (/SCE), an address latch enable signal (SALE), and a write protecting signal (/WP) based on the first control interface.

10. The flash memory control apparatus of claim 8, wherein the second set of control signals further comprise a command latch enable signal (SCLE), a chip enable signal (/SCE), an address latch enable signal (SALE), and a write protecting signal (/WP) based on the second control interface.

11. The flash memory control apparatus of claim 8, wherein the secondary controller further receives a ready/busy (R/B) status signal from the flash memory based on the second control interface.

12. The flash memory control apparatus of claim 11, wherein the primary controller further receives the ready/busy (R/B) status signal from the secondary controller further based on the first control interface.

13. The flash memory control apparatus of claim 8, wherein the first control interface is compatible to NAND flash standard protocol.

14. The flash memory control apparatus of claim 8, wherein the second control interface is compatible to an open NAND flash interface standard protocol.

15. The flash memory control apparatus of claim 8, further comprising a data buffer coupled between the primary controller and the secondary controller, either storing the data from the primary controller according to the first control interface or storing the data from the flash memory according to the second control interface.
